(19) United States
(12) Patent Application Publication
(10) Pub. No.: US 2022/0207229 A1
(43) Pub. Date: Jun. 30, 2022

(54) SYSTEM AND METHOD FOR TEXT STRUCTURING VIA LANGUAGE MODELS

(71) Applicant: YAHOO ASSETS LLC, Dulles, VA (US)

(72) Inventor: Kevin Perkins, Champaign, IL (US)

(21) Appl. No.: 17/138,148

(22) Filed: Dec. 30, 2020

(51) Int. Cl. G06F 40/10; G06F 16/332; G06F 16/335; G06N 5/04; G06N 20/00; G06K 9/62

(52) U.S. Cl. CPC G06F 40/10; G06F 16/3329; G06K 9/6256; G06N 5/04; G06N 20/00; G06F 16/335

(57) ABSTRACT

The present teaching relates to method, system, medium, and implementations for text processing. When a plurality of unstructured text strings are received, an input from a user for at least some of the plurality of unstructured text strings is received that identifies one or more structural elements. Training data are generated to include the plurality of unstructured text strings and the identified one or more structural elements associated with the at least some of the plurality of unstructured text strings. A conversion model is trained, via machine learning, based on the training data and one or more previously trained language models. The conversion model is for converting an input unstructured text string into a structured data record by identifying at least one structural data element from the raw unstructured text string.

### BACKGROUND

### 1. Technical Field

The present teaching generally relates to computer. More specifically, the present teaching relates to text processing.

### 2. Technical Background

In the modern society with ubiquitous presence of network connection and anywhere/anytime accesses, most information either has been digitized or created in digital form and is accessible via electronic means. Significant enhancement to the network security has enabled the tremendous growth of e-commerce in the recent decade. Nowadays, a significant amount of shopping activities occurs on the Internet and continues to grow. Because of that, an increasing percentage of advertisements are placed on the Internet, whether on webpages of manufacturers, distributors, retailers, or other online merchants such as Amazon, eBay, etc.

Given this background, proper and automated dissemination of information in a meaningful way can facilitate quick and on-the-point access to relevant information out of the vast amount of information out there. Given a text string, how to use an automated approach to make the sense of the text string is essential, i.e., how to figure out how to categorize the words in the text string or how to structure the text string in a meaningful way. For example, a product may be described using a text string such as “Fire TV Stick 4K streaming device with Alexa built in, Dolby Vision, includes Alexa Voice Remote, latest release.” in this text string, there are multiple things being described or implied, such as name of the product (Fire TV Stick), name of the brand (Amazon which may be inferred because of the mentioning of Alexa), or product features (resolution is 4K). When different words in a raw text string are put into different categories (product, brand, etc.), the raw text string is considered being structured. Such text structuring is essential, particularly for eCommerce which needs structured data to facilitate, e.g., product search and advertising.

For eCommerce, structured data may be derived from raw text information based on different techniques such as descriptive analytics, predictive modeling, content based recommendation, or clustering and the structured data may facilitate product search based on different characteristics such as name, manufacturer, brand, and specified features. Various text processing approaches have been used to achieve that. For example, natural language processing (NLP) technique called “named entity recognition” (NER) can be used to identify when brands or products from a raw text string.

However, traditional approaches suffer from a number of shortcomings. For instance, in modeling text structuring, traditional approaches generally require a very large corpus for learning with multiple training samples per entity that may occur in a raw text string. Entity choice is usually not dynamic, e.g., a descriptor “resolution” may not apply to all products. Traditional approaches are also not able to carry out inference (such as Amazon being inferred based on the presence of word “Alexa” in the above example). That is, all entity types must be well defined without flexibility. Training a good model for text structuring need also well defined or reliable ground truth training data, which often requires manually creating training data with entities labeled correctly. Combining with the fact that traditional approaches require a very large corpus for training, it makes it very difficult to scale.

Thus, there is a need for methods and systems that allow more effective solutions to address the shortcomings and challenges of the traditional approaches.

### SUMMARY

The teachings disclosed herein relate to methods, systems, and programming for text processing. More particularly, the present teaching relates to methods, systems, and programming related to raw text structuring.

In one example, a method, implemented on a machine having at least one processor, storage, and a communication platform capable of connecting to a network for text processing. When a plurality of unstructured text strings are received, an input from a user for at least some of the plurality of unstructured text strings is received that identifies one or more structural elements. Training data are generated to include the plurality of unstructured text strings and the identified one or more structural elements associated with the at least some of the plurality of unstructured text strings. A conversion model is trained, via machine learning, based on the training data and one or more previously trained language models. The conversion model is for converting an input unstructured text string into a structured data record by identifying at least one structural data element from the raw unstructured text string.

In a different example, a system for text processing includes a user conversion input interface and a data structure conversion learning engine. The user conversion input interface is configured for receiving a plurality of unstructured text strings, obtaining, with respect to at least some of the plurality of unstructured text strings, an input from a user identifying one or more structural elements in the unstructured text string, and then generating training data with the plurality of unstructured text strings and the identified one or more structural elements associated with the at least some of the plurality of unstructured text strings. The data structure conversion learning engine is configured for training, via machine learning, a conversion model based on the training data and one or more previously trained language models, wherein the conversion model is for converting an input unstructured text string into a structured data record by identifying at least one structural data element from the raw unstructured text string.

Other concepts relate to software for implementing the present teaching. A software product, in accord with this concept, includes at least one machine-readable non-transitory medium and information carried by the medium. The information carried by the medium may be executable program code data, parameters in association with the executable program code, and/or information related to a user, a request, content, or other additional information.

In one example, a machine-readable, non-transitory and tangible medium having data recorded thereon for text processing. The data on the medium, once read by the machine, cause the machine to perform the following steps. When a plurality of unstructured text strings are received, an input from a user for at least some of the plurality of unstructured text strings is received that identifies one or more structural elements. Training data are generated to include the plurality of unstructured text strings and the identified one or more structural elements associated with the at least some of the plurality of unstructured text strings. A conversion model is trained, via machine learning, based on the training data and one or more previously trained language models. The conversion model is for converting an input unstructured text string into a structured data record by identifying at least one structural data element from the raw unstructured text string.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary framework for text structuring, in accordance with an exemplary embodiment of the present teaching;

FIG. 2 shows exemplary types of data elements included in an unstructured text string;

FIG. 3 shows exemplary types of structured data organizations;

FIG. 4 shows an example of structuring a text string in terms of different structured data organizations;

FIG. 5 is a flowchart of an exemplary process for text structuring, in accordance with an exemplary embodiment of the preset teaching;

FIG. 6A shows exemplary training data and text structuring result in a CSV organization achieved via learning based on the training data, in accordance with an exemplary embodiment of the preset teaching;

FIG. 6B shows exemplary training data and text structuring result in a JSON organization achieved via learning based on the training data, in accordance with an exemplary embodiment of the preset teaching;

FIG. 6C shows exemplary training data and sentiment text content identified via learning based on the training data, in accordance with an exemplary embodiment of the preset teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching aims to improve the current state of the art in text structuring. Particularly, the present teaching discloses a solution that leverages previously trained language models and carries out machine learning of a conversion model for converting raw unstructured data to structured data. Such a learned conversion model incorporates the knowledge from the previously learned language models so that it is able to be trained quickly using a limited set of training data to learn identifying structural information from raw unstructured data. The learned conversion model is able to not only extract different entities of various categories but also recognize sentiment related text elements and relationships (sometime complex) among different text elements in order to identify the targets associated with the sentiments.

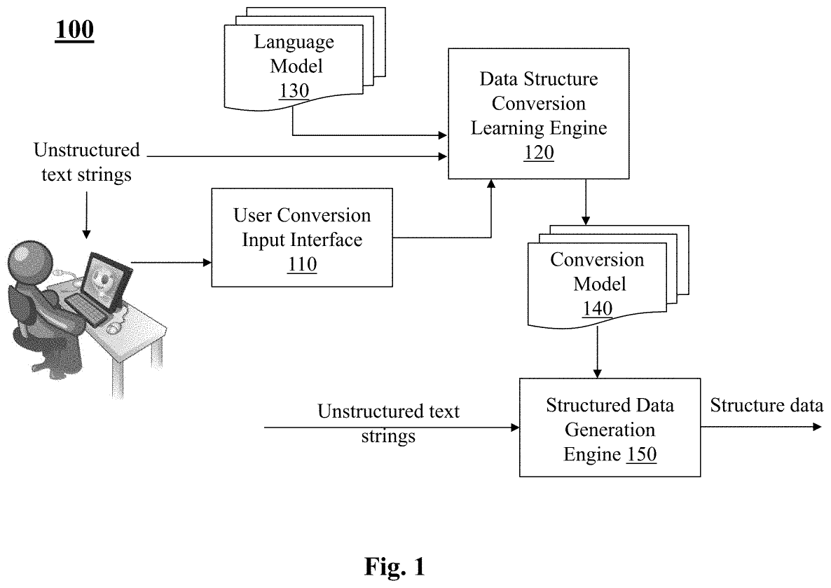

FIG. 1 depicts an exemplary framework 100 for text structuring, in accordance with an exemplary embodiment of the present teaching. In this illustrated framework 100, trained language models 130 are provided that have been previously trained and possess certain knowledge related to language understanding. Leveraging the previously trained language models 130, a data structure conversion learning engine 120 learns, based on training data with some having input from a user via a user conversion input interface 110, a conversion model 140. Via this approach, the conversion model 140 can be trained from limited training data to extract different structural data elements from a raw text string so that such structural data elements may be organized into a structured data record. The training data include, e.g., raw unstructured text strings, some of which may be provided with structural data elements identified manually by a human for training. For example, a raw text string “New iPhone 12 Pro Apple (128 GB, Graphite) [Locked]+Carrier Subscription” my correspond to n input unstructured string and “iPhone 12 Pro” and “Apple” may correspond to two data elements identified by a human from the raw text string for “Product” and “Brand,” respectively. In this example, the training data may be provided in the form of {“New iPhone 12 Pro Apple (128 GB, Graphite) [Locked]+Carrier Subscription,” “iPhone 12 Pro,” “Apple”} corresponding to a structure of {“raw text string,” “Product,” “Brand”}.

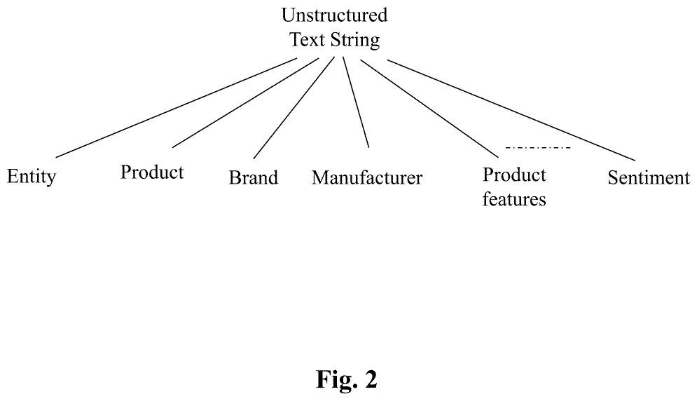

Raw text strings may include different types of data elements. FIG. 2 shows exemplary types of data elements included in an unstructured text string. As illustrated, a raw text string may include entity, product, manufacturer, brand, features, . . . sometimes sentiment related data elements (e.g., “terrible,” “wonderful,” etc.). When different data elements included in a raw unstructured text string are identified, the raw text string can be converted into an organized text structure in a meaningful way. This can be seen in the above example, where a structured data organization {“raw text string,” “Product,” “Brand”} corresponds to a structured data and can be converted from a raw text string “New iPhone 12 Pro Apple (128 GB, Graphite) [Locked]+Carrier Subscription” by identify (1) the raw text string (which is easy), (2) the data element in the raw string that corresponds to a product, and (3) the data element in the raw string that corresponds to a brand.

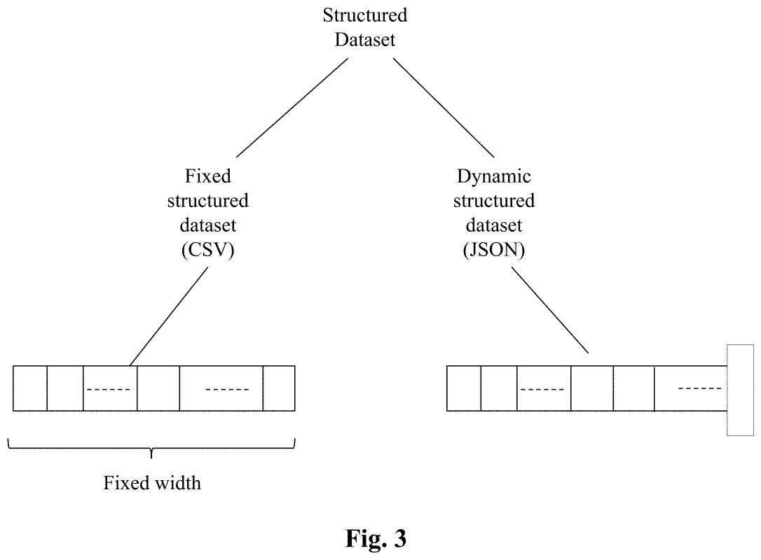

Once the conversion model 140 is trained, it can be used by a structured date generation engine 150 to take an unstructured text string and generate, based on the learned conversion model 140, the corresponding structured data. In some embodiments, the organization of a structured data may be pre-defined. For instance, the example organization of the structured data {“raw text string,” “Product,” “Brand”} may correspond to a fixed data structure with a known number of element (3 here) with specified data elements (Product and Brand). In some embodiments, the structured data produced by the structured data generation engine 150 may have an unspecified length with a variable number of data elements. FIG. 3 shows exemplary types of structured data organizations with or without a fixed number of data elements. As shown, a structure data organization may be a fixed structured data set with multiple rows, each of which corresponds to one structured data record that has a fixed number of data elements or columns. One exemplary known data structure in literature called comma-separated values or CSV is this type of fixed length structured data organization. Another type of structured data set is a dynamic structured data organization with multiple rows of records, each of which is one structured data record that has a variable number of data elements or columns. As shown in FIG. 3, such a structured record have data elements that may vary with situation. For example, one record may have a structure {“raw text string,” “Product,” “Brand”} and another record may have {“raw text string,” “Product,” “Brand,” “Resolution,” “Size”}. When a raw text string is processed and converted into a structured data record, the resultant structured data record may be determined by how many structured data elements are extracted.

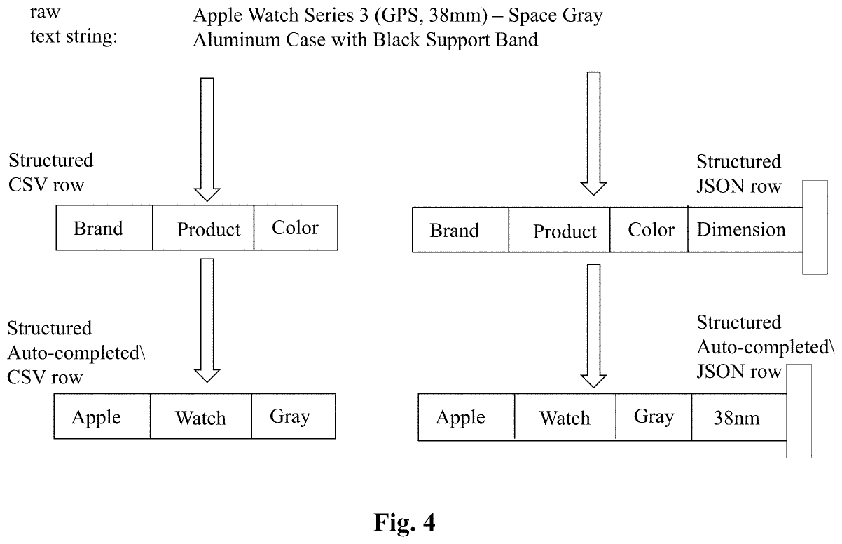

FIG. 4 shows an example of converting a raw unstructured text string into different structured data records. As shown, the raw unstructured text string is “Apple Watch Series 3 (GPS, 38 mm)—Space Gray Aluminum Case with Black Support Band.” If a structured data record is specified as a CSV record with the structure {“Brand,” “Product,” “Color”}, then the raw text string is converted into “{“Apple” “Watch,” “Gray”}. In some embodiments, the raw input text string may also be included in the converted result. In this case, the result is generated by so called auto-fill, i.e., given the first data element (which is the raw unstructured text string), the rest of the data elements are automatically filled based on the content of the given first data element or raw unstructured text string.

In some situations, the converted structured data record may have a different number of data elements extracted from the given raw unstructured text string. That is, what is generated as structured record may not be limited by a certain fixed number of data elements that can be extracted from the raw text string. For example, based on the same example raw text string, the structured data generation engine 150 may also generate a structured data record that has whatever data elements as can be identified. In the example shown in FIG. 4, the raw text string is converted into a structured record with data elements “Brand,” “Product,” “Color,” and “Dimension.”

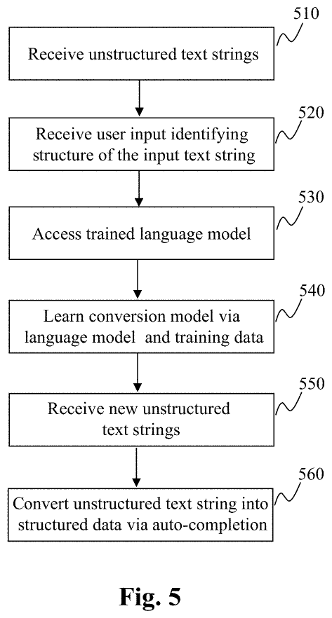

FIG. 5 is a flowchart of an exemplary process for the text structuring framework 100, in accordance with an exemplary embodiment of the preset teaching. As discussed herein, by leveraging previously adequately trained language models, the framework 100 is capable of learning a conversion model based on a small set of training data for converting unstructured data into structured data and, once learned, the conversion model is used to converting input raw unstructured data into structured data. In operation, upon receiving, at 510, raw unstructured text strings, the user conversion input interface 110 receives, at 520, user input that identifies data elements in each of the raw unstructured text string and generates training data for the data structure conversion learning engine 120. As discussed herein, such training data include the raw unstructured text strings and the data elements associated therewith that are identified by the user via the user conversion input interface 110.

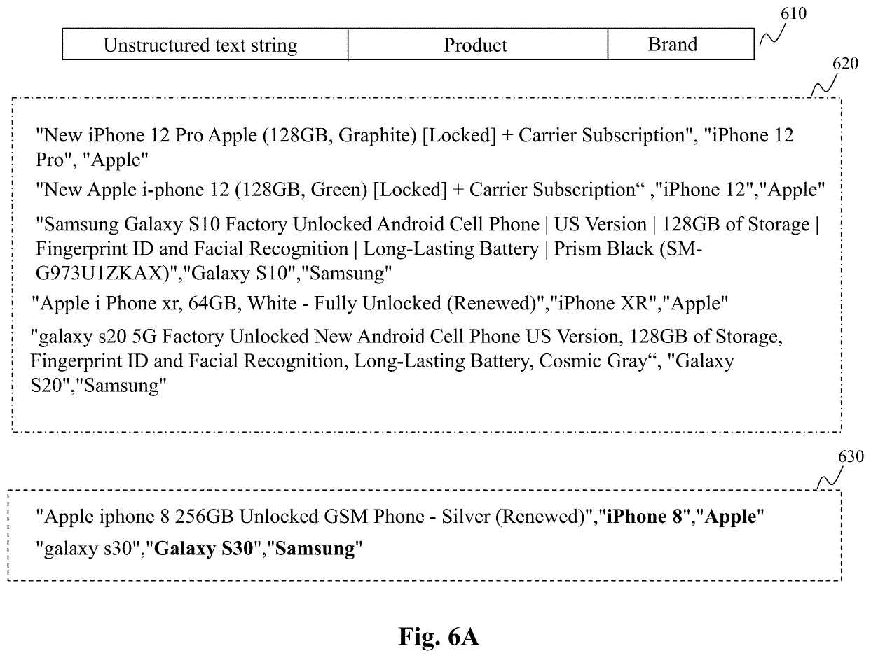

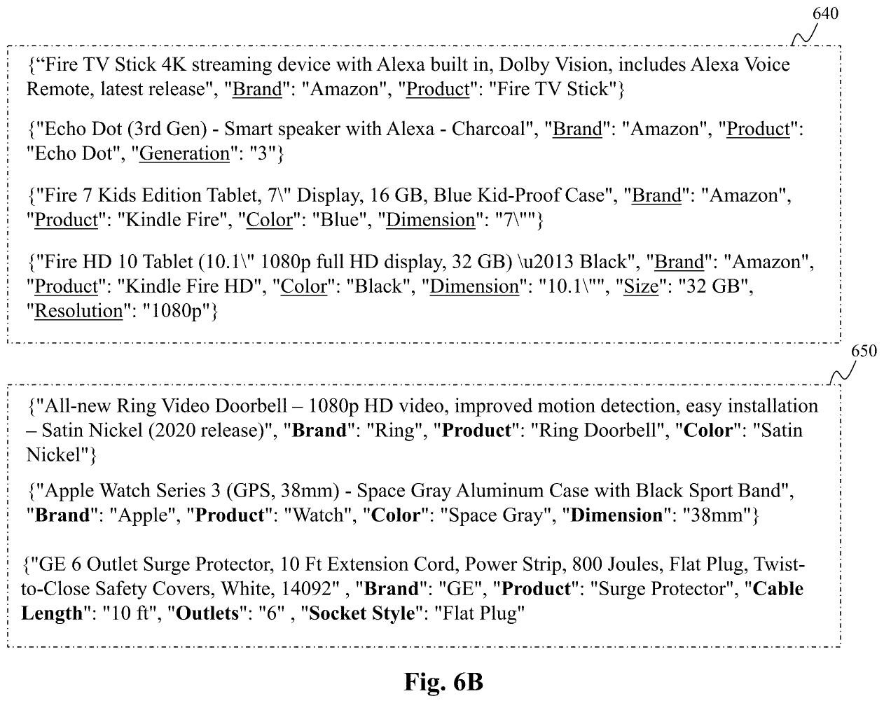

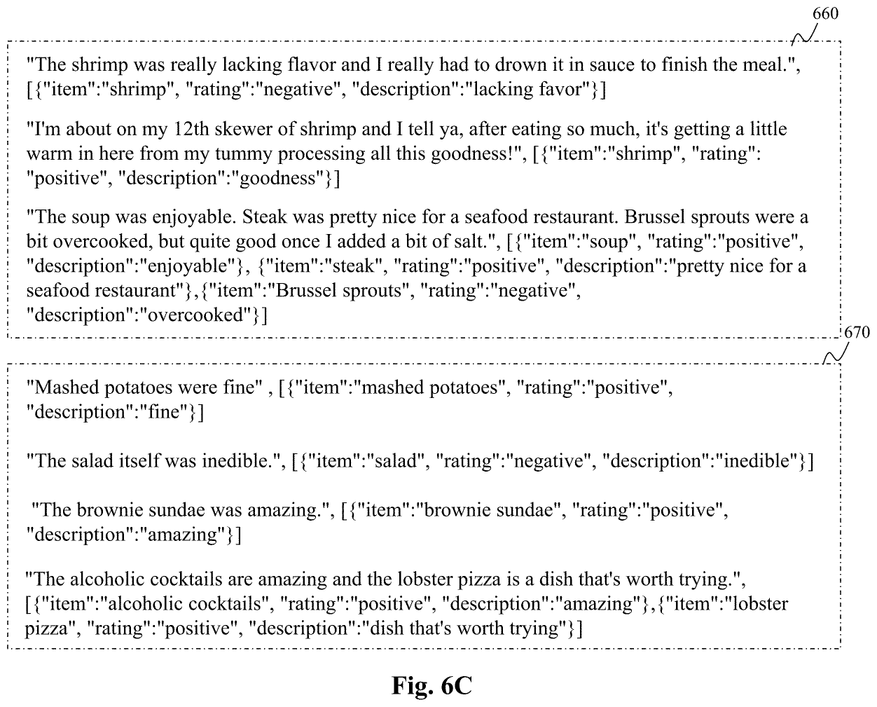

To training the conversion model 140, the data structure conversion learning engine 120 accesses, at 530, the previously trained language models 130 and then learns, at 540, the conversion model 140 based on the training data and the language models 130. As discussed herein, the amount of training data needed to be acquired from the user via manually identifying structured data elements from raw unstructured text strings is quite limited. As the previously trained languages models 130 are fully leveraged during the training of the conversion model 140, the framework 100 as disclosed herein is able to quickly learn the conversion based on a small set of training data. Upon the conversion model 140 is trained, when the structured data generation engine 150 receives, at 550, a raw unstructured text string, it generates a structured data record by converting, at 560, the raw unstructured text string into a structured data record by identifying structural data elements based on the conversion model 140 and automatically filling in different data elements in a structured data record. FIGS. 6A-6C show different exemplary results obtained via the framework 100 in accordance with different embodiments of the present teaching. These exemplary results show that only a quite limited number of training data records is adequate, with the leverage of the previously trained language models, to train the conversion model 140 for identifying structural data elements and forming a structured data record based on such structural data elements.

FIG. 6A shows exemplary training data and text structuring result in a CSV organization achieved via learning based on the limited training data, in accordance with an exemplary embodiment of the preset teaching. In FIG. 6A, 610 denotes the underlying data structure {“raw text string,” “Product,” “Brand”}, 620 represents the training data used for training the conversion model 140, and 630 corresponds to some example of converting unstructured text string to the data structure 610. As seen, in this example, only 5 pieces of training data are used for training the conversion model 140, each of which incudes a raw unstructured text string, product name and brand identified by the user as ground truth for training. For example, based on the first raw text string, “iPhone 12 Pro” corresponds to the Product, “Apple” is the Brand. Similarly, in the second training data record, “iPhone 12” corresponds to the Product, “Apple” is the Brand; in the third training data record, “Galaxy S10” corresponds to the Product, “Samsung” is the Brand; in the fourth training data record, “iPhone XR” corresponds to the Product, “Apple” is the Brand; in the fifth training data record, “Galaxy S20” corresponds to the Product, “Apple” is the Brand. The conversion model 140 trained using these training records is then used to structure a raw unstructured text string “Apple iPhone 8 256 GB Unlocked GSM Phone—Silver (Renewed)” by automatically refilling Product and Brand via extracting, automatically, “iPhone 8” as Product and “Apple” as Brand. Similarly, based on a different raw unstructured text string “galaxy s30,” it is able to identify “Galaxy S30” as Product and inferred, via the learned conversion model 140 (that also incorporates the knowledge from the previously trained language models) that “Samsung” is the Brand.

The examples shown in FIG. 6A are with respect to a fixed length structured data organization as shown in 610. FIG. 6B shows exemplary training data and text structuring result in a JSON organization achieved via learning based on the training data, in accordance with an exemplary embodiment of the preset teaching. In this illustration, the number of training data records 640 is only four but the conversion model 140 learned based on such a small set of training data is able to be used to converting unstructured raw text string into structured data records of variable lengths. As shown, for each raw unstructured text string in the training data, the user identified different data elements. Such identified data elements serve as ground truth to train the conversion model 140. As variable lengths training is used, the attribute name for each identified data element is marked underlined for ease of understanding. In addition, different data elements are identified for different training records. For example, for the first training record, Brand and Product related data elements are identified; in the second training data record, Brand, Product, and Generation (a product feature) are identified; in the third training record, Brand, Product, Color, and Dimension are identified; and in the fourth training data record, Brand, Product, Color, Dimension, Size, and Resolution are all identified.

Based on such 4 training data records, 650 in FIG. 6B represents the data structuring results obtained based on the conversion model 140 trained using the training data in 640. As can be seen, not only Brand and Product are automatically identified from given raw unstructured text strings, a variable number of structured data elements are also extracted. From the first raw text string, Brand, Product, and Color are extracted; from the second raw text string, Brand, Product, Color, Dimension are extracted; and from the third raw text string, Brand, Product, Cable Length, Outlets, and Socket Style are extracted automatically. Those data elements extracted from the raw text strings then can be used to generate the respective structured data records, e.g., with data elements starting with the corresponding raw text string followed by various data elements extracted from the input raw text string.

According to the present teaching, the learning scheme with leveraged language models 130 also enable the conversion model 140 to learn to extract sentiment related data elements based on training data with sentiment related ground truth. Similarly, the required amount of training data created via manual user input via the user conversion input interface 110 can be kept quite limited but the learned conversion model 140 is able to learn quickly because of the leverage gained from the language models 130. FIG. 6C shows exemplary training data and sentiment text content identified via learning based on the training data, in accordance with an exemplary embodiment of the preset teaching. In this Figure, 660 represents the training data used and as can be seen, it involves three records each of which provides a raw text string that includes sentiment related comments. For example, the first raw training text string states “The shrimp was really lacking favor and I really had to drown it in sauce to finish the meal.” The training data record provides not only the data elements from the text string related to sentiment (“lack of flavor”) but also the item to which the sentiment is directed. That is, for each sentiment expressed, there is a related item, i.e., the sentiment is directed to an item indicated in the raw text string. In the above example, the sentiment is “lacking flavor” and its related item is “shrimp.” In addition, in this example, based on the sentiment, there is an inferred rating for the item based on the sentiment, i.e., a rating of “negative” in the training data is not from the raw text string but inferred from the sentiment. Similar observation may also be made with respect to the rest two training data records. The third training data record includes three separate sentiments (enjoyable, pretty nice, overcooked) expressed with respect to three different items (soup, steak, Brusslesprouts) so that three corresponding ratings are inferred (positive, positive, and negative).

These three training data records are used by the conversion model learning engine 120 in connection with the language models 130. The resultant conversion model 140 is then used by the structured data generation engine 150 to generate sentiment related structured data elements, as shown in 670. Four testing raw text strings are processed to produce corresponding extracted/inferred structured data elements. For example, for raw text string “Mashed potatoes were fine,” the structured data generation engine 150 generates the structured data record {“item”: “mashed potatoes”, “rating”: “positive”, “description”: “fine”}, by extracting item “mashed potatoes,” the sentiment description “fine,” and inferring a rating of “positive” based on the sentiment word “fine” as extracted. Similar can be seen for the second and third raw text strings. For the last raw text string “The alcoholic cocktails are amazing and the lobster pizza is a dish that's worth trying,” there are multiple items for which sentiments are expressed. The result of using the learned conversion model 140 is [{“item”: “alcoholic cocktails”, “rating”: “positive”, “description”: “amazing”}, {“item”: “lobster pizza”, “rating”: “positive”, “description”: “dish that's worth trying”}]. Thus, the results show that by leveraging adequately trained language models 130, the training for converting unstructured data to structured data require only a small set of training data and the conversion model so trained can quickly learn and used to converting unstructured data to structured data.

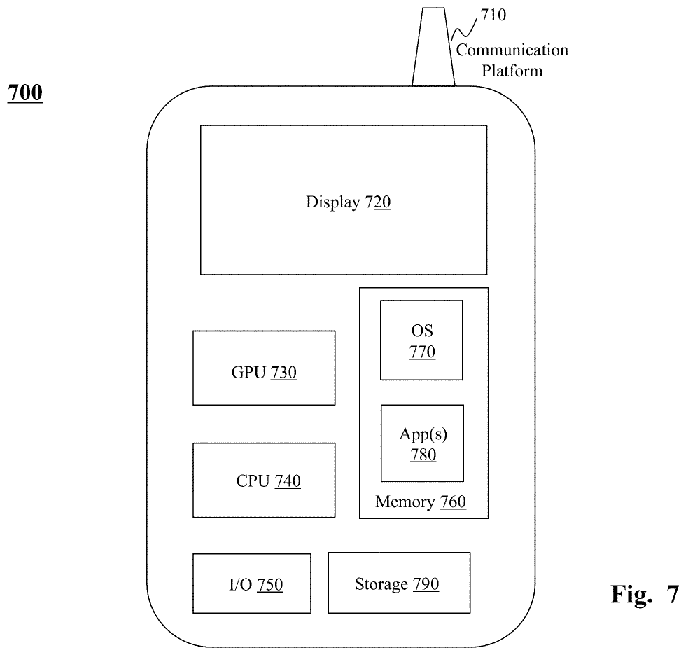

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but is not limited to, a smart phone, a tablet, a music player, a handled gaming console, a global positioning system (GPS) receiver, and a wearable computing device (e.g., eyeglasses, wrist watch, etc.), or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 740. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a browser or any other suitable mobile apps for managing a machine learning system according to the present teaching on mobile device 700. User interactions, if any, may be achieved via the I/O devices 740 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

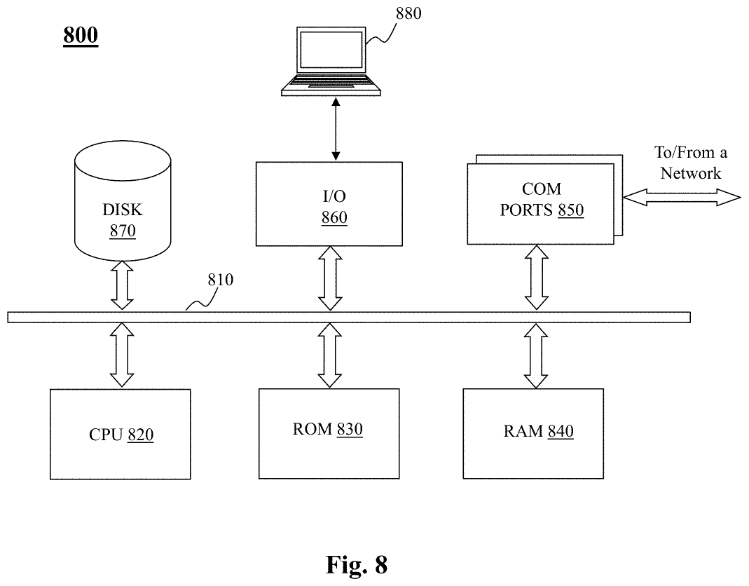

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general purpose computer or a special purpose computer. Both can be used to implement a specialized system for the present teaching. This computer 800 may be used to implement any component or aspect of the framework as disclosed herein. For example, the learning system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with conversation management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the fraudulent network detection techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine including at least one processor, memory, and communication platform capable of connecting to a network for text processing, the method comprising:
receiving a plurality of unstructured text strings;
receiving, with respect to at least some of the plurality of unstructured text strings, an input from a user identifying one or more structural elements in the unstructured text string;
generating training data comprising the plurality of unstructured text strings and the identified one or more structural elements associated with the at least some of the plurality of unstructured text strings; and
training, via machine learning, a conversion model based on the training data and one or more previously trained language models, wherein the conversion model is for converting an input unstructured text string into a structured data record by identifying at least one structural data element from the raw unstructured text string.

2. The method of claim 1, wherein
each of the unstructured text string corresponds to a description related to a product; and
the structured data record converted from an unstructured text string describing the product includes at least one of a product name, a brand name for the product, and one or more features of the product.

3. The method of claim 1, wherein the structured data record is a fixed length with a pre-determined number of structural data element; or
a variable length with a variable number of structural data element.

4. The method of claim 1, wherein a structural data element is one of an entity, a product, a brand, a manufacturer, a feature, and a sentiment, extracted from the unstructured text string.

5. The method of claim 4, wherein a structural data element is further an inference derived based on content of the unstructured text string.

6. The method of claim 1, further comprising
receiving the input unstructured text string;
accessing the conversion model;
extracting, based on the conversion model, one or more structural data elements from the input unstructured text string; and
generating the structured data record based on the one or more structural data elements.

7. The method of claim 6, wherein the structured data record further comprises at least one of the input unstructured text string and a data element inferred based on the one or more structural data elements.

8. Non-transitory and machine readable medium having information recorded thereon for text processing, wherein the information, when read by the machine, causes the machine to perform:
receiving a plurality of unstructured text strings;
receiving, with respect to at least some of the plurality of unstructured text strings, an input from a user identifying one or more structural elements in the unstructured text string;
generating training data comprising the plurality of unstructured text strings and the identified one or more structural elements associated with the at least some of the plurality of unstructured text strings; and
training, via machine learning, a conversion model based on the training data and one or more previously trained language models, wherein the conversion model is for converting an input unstructured text string into a structured data record by identifying at least one structural data element from the raw unstructured text string.

9. The medium of claim 8, wherein
each of the unstructured text string corresponds to a description related to a product; and
the structured data record converted from an unstructured text string describing the product includes at least one of a product name, a brand name for the product, and one or more features of the product.

10. The medium of claim 8, wherein the structured data record is
a fixed length with a pre-determined number of structural data element; or
a variable length with a variable number of structural data element.

11. The medium of claim 8, wherein a structural data element is one of an entity, a product, a brand, a manufacturer, a feature, and a sentiment, extracted from the unstructured text string.

12. The medium of claim 11, wherein a structural data element is further an inference derived based on content of the unstructured text string.

13. The medium of claim 8, wherein the information, when read by the machine, further causes the machine to perform:
receiving the input unstructured text string;
accessing the conversion model;
extracting, based on the conversion model, one or more structural data elements from the input unstructured text string; and
generating the structured data record based on the one or more structural data elements.

14. The medium of claim 13, wherein the structured data record further comprises at least one of the input unstructured text string and a data element inferred based on the one or more structural data elements.

15. A system for text processing, comprising:
a user conversion input interface implemented on a processor and configured for receiving a plurality of unstructured text strings,
receiving, with respect to at least some of the plurality of unstructured text strings, an input from a user identifying one or more structural elements in the unstructured text string, and
generating training data comprising the plurality of unstructured text strings and the identified one or more structural elements associated with the at least some of the plurality of unstructured text strings; and
a data structure conversion learning engine implemented on a processor and configured for training, via machine learning, a conversion model based on the training data and one or more previously trained language models, wherein the conversion model is for converting an input unstructured text string into a structured data record by identifying at least one structural data element from the raw unstructured text string.

16. The system of claim 15, wherein
each of the unstructured text string corresponds to a description related to a product; and
the structured data record converted from an unstructured text string describing the product includes at least one of a product name, a brand name for the product, and one or more features of the product.

17. The system of claim 15, wherein the structured data record is
a fixed length with a pre-determined number of structural data element; or
a variable length with a variable number of structural data element.

18. The system of claim 15, wherein a structural data element is one of an entity, a product, a brand, a manufacturer, a feature, and a sentiment, extracted from the unstructured text string or an inference inferred based on content of the unstructured text string.

19. The system of claim 15, further comprising a structured data generation engine implemented on a processor and configured for:
receiving the input unstructured text string;
accessing the conversion model;
extracting, based on the conversion model, one or more structural data elements from the input unstructured text string; and
generating the structured data record based on the one or more structural data elements.

20. The system of claim 19, wherein the structured data record further comprises at least one of the input unstructured text string and a data element inferred based on the one or more structural data elements.
